(19) United States
(12) Patent Application Publication
(10) Pub. No.: US 2016/0110636 A1
(43) Pub. Date: Apr. 21, 2016

(54) ELECTRONIC DEVICE INFORMATION READ/WRITE MECHANISM AND ELECTRONIC DEVICE INFORMATION READ/WRITE METHOD

(71) Applicant: NEC DISPLAY SOLUTIONS, LTD., Mita-ku, Tokyo (JP)

(72) Inventor: Yoshihiro TAKECHI, Tokyo (JP)

(73) Assignee: NEC Display Solutions Ltd., Minato-ku, Tokyo (JP)

(21) Appl. No.: 14/892,178

(22) PCT Filed: May 21, 2013
(86) PCT No.: PCT/JP2013/064032

§ 371 Date: Nov. 18, 2015

(51) Int. Cl. G06K 19/07

(52) U.S. Cl. CPC G06K 19/0716

(57) ABSTRACT

An electronic device information read/write mechanism includes an RF tag attached to a metal frame at the upper portion of a liquid crystal display panel packed in a packaging box. The RF tag stores the internal information concerning the liquid crystal display panel. The packaging box is partially opened to expose the RF tag to the outside, and then an external reader/writer is moved close to the RF tag, and therefore the external reader/writer reads or writes the internal information stored in the RF tag without powering on the liquid crystal display panel.

### TECHNICAL FIELD

The present invention relates to an electronic device information read/write mechanism, which can read or write electronic device information by use of an RF (Radio Frequency) tag attached to an electronic device such as a liquid crystal display panel packed in a packaging material, and an electronic device information read/write method.

### BACKGROUND ART

Conventionally, it is necessary to once power on an electronic device so as to read or write the internal information of an electronic device. For this reason, it is necessary to unpack the packaging box packing an electronic device and then power on an electronic device. This is a troublesome and time-consuming job causing a considerable burden in operation.

For example, Patent Literature Document 1 discloses a multi-screen display device which is designed to select a video display device being operated using a remote controller from among a plurality of video display devices for the purpose of screen adjustment.

### CITATION LIST

### Patent Literature Document

Patent Literature Document 1: Japanese Patent Application Publication No. 2010-79127

### SUMMARY OF INVENTION

### Technical Problem

In the video display device disclosed in Patent Literature Document 1, however, it is necessary to power on each video display device in order to effectively operate a remote controller. For the video display devices being packed, it is necessary to once unpack the packages and then once power on each video display device. This is a troublesome and time-consuming job causing a considerable burden to an operator.

The present invention aims to provide an electronic device information read/write mechanism and an electronic device information read/write method, which can read and/or write the information of an electronic device packed in a packaging container without powering on an electronic device.

### Solution to Problem

The present invention is directed to an information read/write mechanism for an electronic device including a wireless communication part, which is attached to one end of the electronic device packed in a packaging container and stores information concerning the electronic device, wherein at least part of the packaging container is opened to expose the wireless communication part to the outside, thus allowing an external wireless communication terminal to read or write the information stored in the wireless communication part without powering on the electronic device.

The present invention is directed to an information read/write method for an electronic device, comprising the steps of: opening at least part of a packaging container packing an electronic device therein, thus exposing a wireless communication part which is attached to the electronic device so as to store information concerning the electronic device; and reading or writing the information stored in the wireless communication part with an external wireless communication terminal without powering on the electronic device.

### Advantageous Effects of Invention

In an electronic device information read/write mechanism and an electronic device information read/write method according to the present invention, it is possible to partially unpack a packaging container, including an electronic device having a wireless transceiver attached thereto, and expose the wireless transceiver to the outside, and therefore it is possible to move the wireless communication terminal close to the wireless transceiver and to allow the wireless communication terminal to communicate with the wireless transceiver without powering on the electronic device, thus reading or writing the information concerning the electronic device.

### BRIEF DESCRIPTION OF DRAWINGS

FIG. 1 is a perspective view of a liquid crystal display panel according to the embodiment of the present invention.

FIG. 2 is an enlarged and exploded perspective view of an RF tag and a bezel attached to a metal frame of the liquid crystal display panel shown in FIG. 1.

FIG. 3 is an exploded perspective view showing the configuration of an RF tag oriented to the NFC.

FIG. 4 is a front view of the RF tag shown in FIG. 3.

FIG. 5 is a horizontal sectional view of the RF tag shown in FIG. 4.

FIG. 6A is a state diagram showing the liquid crystal display panel which is stored and packed in a packaging box.

FIG. 6B is a diagram showing a process of removing top flaps, used to protect the upper face of the liquid crystal display panel, from a packing box.

FIG. 6C is a diagram showing a process of carrying out a read/write operation using a reader/writer located opposite to an RF tag on the upper face of the liquid crystal display panel.

FIG. 7 is a flowchart showing a process of reading or writing the internal information of the liquid crystal display panel by use of an RF tag on the upper face of the liquid crystal display panel which is once packed and then unpacked.

### DESCRIPTION OF EMBODIMENTS

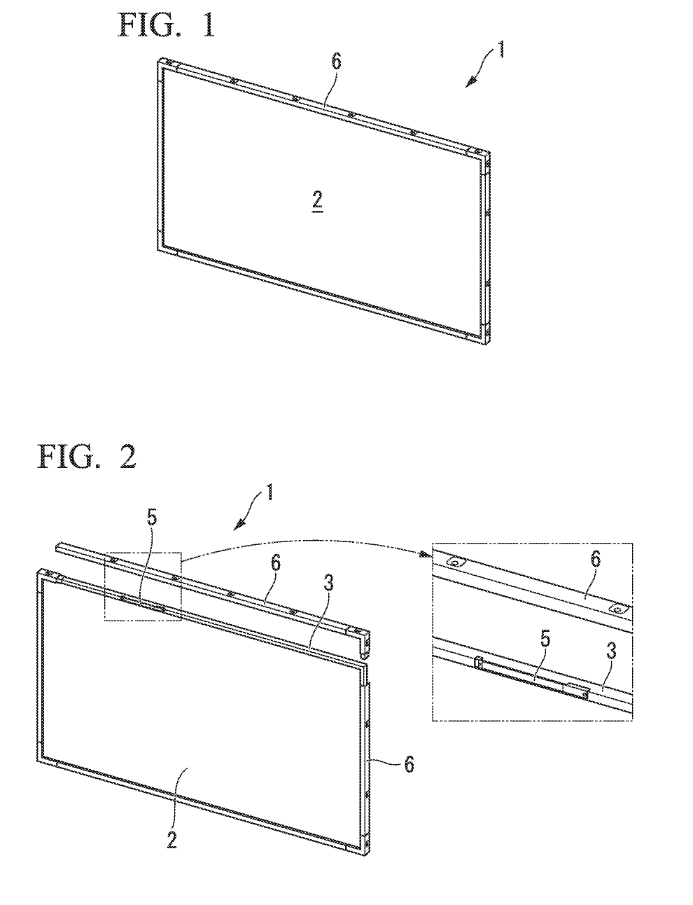

An information read/write mechanism and an information read/write method with a liquid crystal display panel according to the embodiment of the present invention will be described with reference to FIGS. 1 to 7.

FIGS. 1 and 2 show a liquid crystal display panel 1 serving as an example of an electronic device. For example, the liquid crystal display panel 1 includes a display 2, having a rectangular plate shape, and a metal frame 3 covering the outer periphery and formed along the four sides of the display 2. For example, an RF tag 5 serving as a wireless transceiver storing the internal information of the liquid crystal display panel 1 is attached on to the upper portion of the surface of the display 2. Additionally, a bezel 6 serving as a rectangular frame is attached to the display 2 so as to cover the metal frame 3 and the RF tag 5. The bezel 6 covers the peripheral face of the liquid crystal display panel 1 as well as the outer periphery of the surface of the display 2.

In the example of FIG. 2, the RF tag 5 is attached to the position which is shifted leftwards from the center of the upper end of the display 2; but this position is not a restriction.

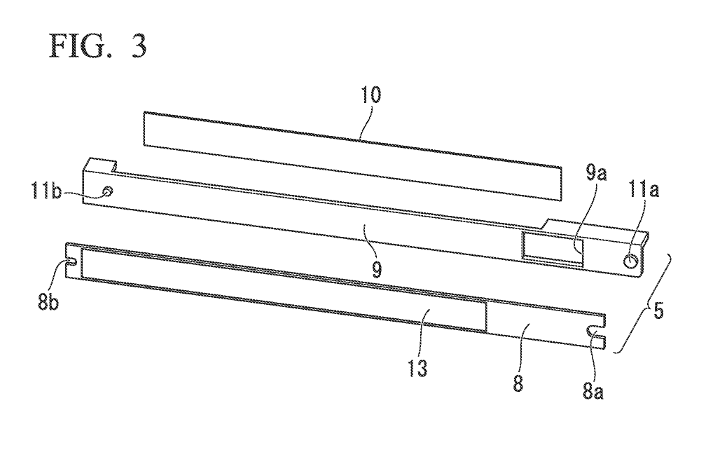

The RF tag 5 attached to the metal frame 3 is an NFR (Near Field Communication) tag having a near-field communication function. As shown in FIGS. 3 to 5, for example, the RF tag 5 includes an RF tag substrate 8 having a plate-like shape and a holder 9, which are laminated together and mutually adhered together using a double-sided tape. A magnetic sheet 10 is adhered to the back face of the holder 9 by use of a double-sided tape. For example, the RF tag 5 is attached to the face of the metal frame 3, close to the display 2, by way of the magnetic sheet 10 via an adhesive layer such as a double-sided tape.

A pair of positioning pins 11a, 11b serving as positioning members is attached to the holder 9 at the opposite ends, while a pair of recesses 8a, 8b engaged with a pair of positioning pins 11a, 11b is formed in the RF tag 8 at the opposite ends. Using these positioning parts, it is possible to determine the positions of the RF tag substrate 8 and the holder 9 and to laminate them together, thus setting the positional relationship between them.

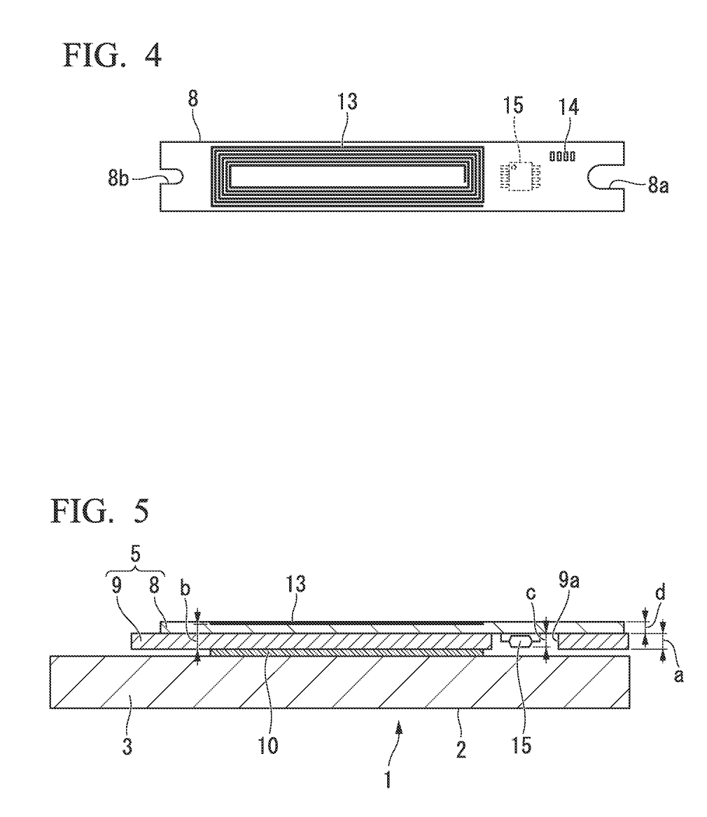

Next, the RF tag 5 will be described. In FIG. 4, an antenna 13 made of an antenna coil is attached to the front face of the RF tag 8 (i.e. the same side as the display 2). The antenna 13 is formed using a copper line shaped like a coil.

Additionally, a terminal 14 connectible to an FPC (i.e. a flexible printed-circuit board) is formed on the front face of the RF tag substrate 8. An FCP, not shown, connected to the terminal 14 is connected to a main substrate of the display 2 of the liquid crystal display panel 1. Both the RF tag substrate 8 and the main substrate of the display 2 are connected to the FCP; hence, it is possible to synchronize the internal information stored in the RF tag substrate 8 with the internal information stored in the main substrate when powering on the liquid crystal display panel 1. This makes it possible to read or write the internal information with those substrates.

An electrical component 15 including an NFC controller and a storage medium such as a non-touch IC is mounted on the back face of the RF tag substrate 8. The electrical component 15 stores the internal information of the liquid crystal display panel 1 such as a firmware version, a setting status, and an ID. The electrical component 15 is fabricated at a specific position circumventing a back area opposite to a front-face area of the RF tag substrate 8. In FIG. 5, an opening 9a of the holder 9 is formed in conformity with the position of the electrical component 15; hence, the electrical component 15 is positioned inside the opening 9a. The thickness of the holder 9 at the opening 9a is set to be larger than the thickness of the electrical component 15. For example, the thickness a of the holder 9 is 1.3 mm while the thickness of the electrical component 15 is 1.2 mm; hence, it is possible to prevent the electrical component 15, attached to the back face of the RF tag substrate 8, from protruding from the back face of the holder 9. Thus, a small thickness is set to the RF tag 5.

When a reader/writer 20 serving as a wireless communication terminal which will be discussed later approaches the RF tag 5, for example, it is possible to supply power to the electrical component 15 of the RF tag substrate 8 by means of the reader/writer 20 producing a magnetic field via the antenna 13, thus carrying out a communication with the reader/writer 20.

In this case, an eddy current occurs in the metal frame 3 in proximity to the RF tag 5 in a magnetic field of the reader/writer 20; hence, this may cancel out a magnetic field necessary to carry out a communication. To prevent this event, the magnetic sheet 10 is interposed between the RF tag 5 and the metal frame 3. The magnetic sheet 10 is attached to the holder 9 while the RF tag 5 is attached to the metal frame 3 together with the magnetic sheet 10. The RF tag 5 is attached to the face of the metal frame 3 of the liquid crystal display panel 1, on the same side as the display 2, through the magnetic sheet 10. In this connection, FIG. 5 does not show the bezel 6.

For example, it is preferable that the antenna 13 be distanced from the magnetic sheet 10 by b=2.2 mm or more. This allows a magnetic field of the reader/writer 20 to penetrate through the antenna 13 of the RF tag substrate 8, thus maintaining an adequate communication.

It is possible to set a small thickness for the display 2 since the RF tag 5 is interposed between the bezel 6 and the metal frame 3. As a result, it is possible to reduce the installation area of the liquid crystal display panel 1.

An example of numerical values concerning the RF tag 5 according to the present embodiment will be described below.

For example, the height (or thickness) c of the electrical component 15 is 1.2 mm while the thickness of the holder 9 is d=1.3 mm which is larger than the height of the electrical component 15. Additionally, the thickness of the RF tag substrate 8 is 1.0 mm, and therefore the distance between the antenna 13 and the magnetic sheet 10 is 2.3 mm; hence, it is possible to maintain the distance to be larger than the total thickness of 2.2 mm combining the RF tag substrate 8 and the electrical component 15. That is, the antenna 13 is disposed on the surface of the RF tag substrate 8 unconnected to the holder 9; the electrical component 15 is disposed on the opposite back face; and the thickness of the holder 9 is increased to be larger than the height of the electrical component 15. Thus, it is possible to secure an adequate distance between the antenna 13 and the metal frame 3.

Thus, it is possible to realize the contradictory requirements, i.e. it is possible to reduce the thickness of the RF tag 5 while securing an adequate distance between the antenna 13 and the metal frame 3. In a multi-screen display device having an array of liquid crystal display panels 1, it is necessary to reduce the width of the bezel 6 extended along the display 2 in order to improve visibility. For this reason, an operation button such as a power button, which is conventionally arranged in the bezel 6 on the front face of the liquid crystal display panel 1, should be arranged on the back face of the display 2. In this case, it is preferable to arrange the RF tag 5 oriented to the NFC on the back face of the display 2 together with an operation button. That is, it is preferable that the RF tag 5 be arranged on the same face as the face arranging an operation part of the liquid crystal display panel 1. This makes it easy to install the RF tag 5 with the operation part, thus simplifying the manufacturing process.

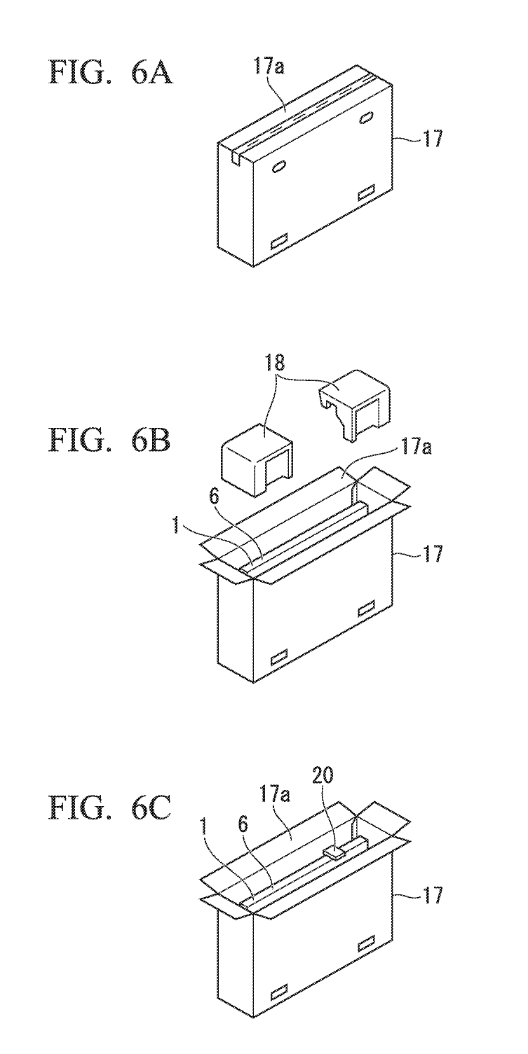

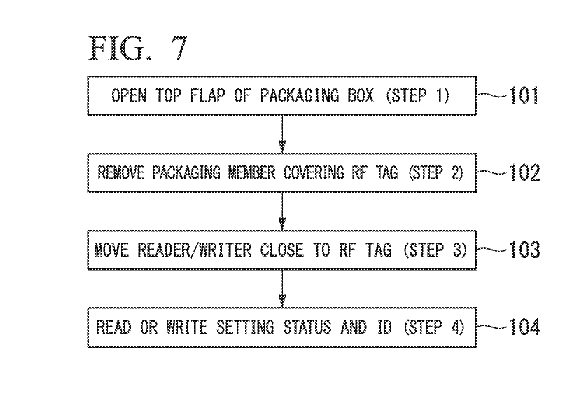

The liquid crystal display panel 1 of the present embodiment has the above configuration. A method of reading or writing the internal information of the liquid crystal display panel 1 stored and packed in a packaging box 17 will be described with reference to the process diagrams shown in FIGS. 6A, 6B, 6C and the flowchart shown in FIG. 7. FIG. 6A shows the liquid crystal display panel 1 completely packed in the packaging box 17. In the condition shown in FIG. 6A in which the liquid crystal display panel 1 stored inside the box, the RF tag 5 is interposed between the bezel 6 and the metal frame 3 on the upper side of the liquid crystal display panel 1 and positioned in the top side of the packaging box 17. In this condition, as shown in FIG. 6B, a top flap 17a serving as a cover of the packaging box 17 is opened (step 101), and then a pair of cushion members 18 made of a styrene foam or a corrugated cardboard is removed from the packaging box 17 (step 102). Thus, it is possible to expose the upper portion of the liquid crystal display panel 1 in the upper opening of the packaging box 17.

In this condition, as shown in FIG. 6C, the externally provided reader/writer 20 is moved close to the NFC-oriented RF tag 5, which is interposed between the bezel 6 and the metal frame 3 on the upper side of the liquid crystal display panel 1 (step 103).

Due to a magnetic field of the reader/writer 20, power is supplied to the RF tag substrate 8 through the antenna 13, and therefore the reader/writer 20 communicates with the electrical component 15 so as to read or write the internal information, such as a firmware version, a setting status, and an ID, stored in the electrical component 15 (step 104).

At this time, it is possible to prevent cancellation of a magnetic field necessary to carry out a communication due to an eddy current occurring in the metal frame in proximity to the RF tag 5 in a magnetic field of the reader/writer 20.

Upon receiving an electromagnetic wave from the reader/writer 20, the RF tag 5 supplies a reception confirmation signal to the reader/writer 20 in step 104. Upon receiving the internal information from the reader/writer 20, the electrical component 15 of the RF tag 5 supplies the internal information to the reader/writer 20.

As described above, according to the information read/write mechanism and the information read/write method of the liquid crystal display panel 1 of the present embodiment, it is possible to carry out a communication between the RF tag 5 and the reader/writer 20 moved close to the RF tag 5 without powering on the liquid crystal display panel 1 after opening the top flap 17a of the packaging box 17, storing the liquid crystal display panel 1 equipped with the RF tag 5 therein, and exposing the RF tag 5 to the outside, thus carrying out read/write operations on the internal information of the liquid crystal display panel 1.

According to the information read/write mechanism and the information read/write method of the liquid crystal display panel 1 of the present embodiment, it is possible to easily confirm and change a setting status and an ID for each of the liquid crystal display panels 1 configuring a multi-screen display device. The ID does not necessarily indicate the unique manufacturing number for each liquid crystal display panel 1 but also indicates the ID information representing which part of a video is displayed by each of the liquid crystal display panels 1 configuring a multi-screen display device. For this reason, it is possible for the reader/writer 20 to recognize the ID information representing which part of a multi-screen corresponds to each of the liquid crystal display panels 1, which are packed in a box, before setting up a multi-screen display device. Additionally, it is possible to smoothly assemble the parts of a multi-screen display device with recognition.

When the position of fixing the RF tag 5 to the liquid crystal display panel 1 is set to the center of the metal frame 3 on the upper end of the liquid crystal display panel 1, for example, it is possible to move the reader/writer 20 close to the RF tag 5 without removing the packaging material such as the cushion member 18, thus carrying out read/write operations. In this case, it is possible to preclude the process of removing the packaging material such as the cushion member 18 from the packaging box 17; hence, it is possible to easily read or write the information, stored in the RF tag 5 of the liquid crystal display panel 1, with the externally provided reader/writer.

In this connection, the present invention is not necessarily limited to the liquid crystal display panel 1 but applicable to various types of electronic devices each implementing an information read/write mechanism and an information read/write method.

### INDUSTRIAL APPLICABILITY

The present invention is applicable to various types of electronic devices such as liquid crystal display panels equipped with wireless communication parts, such as NFC-oriented RF tags storing the internal information concerning electronic devices, at one ends of electronic devices; hence, the present invention allows wireless communication terminals, such as external reader/writers, to read or write the information stored in wireless communication parts without powering on electronic devices stored in packaging containers having packaging materials being partially opened.

### REFERENCE SIGNS LIST

1 liquid crystal display panel
1 display
3 metal frame
5 RF tag
8 RF tag substrate
9 holder
10 magnetic sheet
13 antenna
14 terminal of FPC
15 electrical component
17 packaging box
18 cushion material
20 reader/writer

1. An information read/write mechanism for an electronic device including a wireless communication part, which is attached to one end of the electronic device packed in a packaging container and stores information concerning the electronic device, wherein at least part of the packaging container is opened to expose the wireless communication part to an outside, thus allowing an external wireless communication terminal to read or write the information stored in the wireless communication part without turning on power with the electronic device.

2. The information read/write mechanism for an electronic device according to claim 1, wherein the wireless communication part includes a substrate installing an antenna on a surface and a holder attached to a back face opposite to the surface of the substrate, and wherein a magnetic sheet is attached to a back face of the holder.

3. The information read/write mechanism for an electronic device according to claim 2, wherein an electrical component storing the information concerning the electronic device is mounted on the back face of the substrate of the wireless communication part, and wherein an opening is formed in the holder, stores the electrical component therein, and prevents the electrical component from protruding from the back face.

4. The information read/write mechanism for an electronic device according to claim 1, wherein the electronic device comprises a display device.

5. The information read/write mechanism for an electronic device according to claim 4, wherein the display device includes a liquid crystal display and a frame, and wherein the wireless communication part is attached to a metal frame covering an external periphery of the liquid crystal display and stored inside the frame.

6. The information read/write mechanism for an electronic device according to claim 4, wherein the wireless communication part is attached to a same face as an operation part of the display device.

7. An information read/write method for an electronic device, comprising:
opening at least part of a packaging container packing an electronic device therein, thus exposing a wireless communication part which is attached to the electronic device and stores information concerning the electronic device; and
reading or writing the information stored in the wireless communication part with an external wireless communication terminal without turning on power with the electronic device.

8. The information read/write method for an electronic device according to claim 7, wherein the electronic device comprises a display device, and wherein the information read/write method further comprises:
removing a cushion material covering the wireless communication part; and
moving the wireless communication terminal close to the wireless communication part, thus reading or writing a setting status and an ID of the display device.
